(19) United States
(12) Patent Application Publication
(10) Pub. No.: US 2015/0081552 A1
(43) Pub. Date: Mar. 19, 2015

(54) SYSTEM FOR VERIFYING AN IDENTITY OF A CARD HOLDER

(71) Applicant: SONAVATION, INC., PALM BEACH GARDENS, FL (US)

(72) Inventor: ROBERT EDWIN STEWART, JUPITER, FL (US)

(21) Appl. No.: 14/488,132

(22) Filed: Sep. 16, 2014

Related U.S. Application Data
(60) Provisional application No. 61/878,529, filed on Sep. 16, 2013.
(60) Provisional application No. 61/881,384, filed on Sep. 23, 2013.

(51) Int. Cl. G06Q 20/40; H04L 29/08; H04L 29/06

(52) U.S. Cl. CPC G06Q 20/40145; H04L 63/0861; H04L 67/10
USPC 705/44

(57) ABSTRACT

A system for verifying an identity of a card holder. The system is designed for obtaining a geographically remote biometric scan of a card holder's fingerprint, and optionally for obtaining other actions from the card holder, as one or more condition(s) for completing performance of a transaction, or for verification of a performance of a transaction, in association with the card. The transaction may involve performance of actions of a financial nature, and/or may involve performance of actions for verifying proximity and/or location of a card holder, and/or for providing physical access to a secure facility by a card holder.

This document is a United States non-provisional utility patent application that claims priority and benefit under 35 U.S.C. 119 (e) to co-pending U.S. (utility) provisional patent application having Ser. No. 61/878,529, (Confirmation No. 5114), (Docket Number: SON-031P), and that was filed on Sep. 16, 2013 and that is entitled “SYSTEM FOR VERIFYING AN IDENTITY OF A CARD HOLDER”, and which is incorporated herein by reference in it's entirely.

This document further claims priority and benefit under 35 U.S.C. 119 (e) to co-pending U.S. (utility) provisional patent application having Ser. No. 61/881,384, (Confirmation No. 1314), (Docket Number: SON-031P2), and that was filed on Sep. 23, 2013 and that is entitled “SYSTEM FOR VERIFYING AN IDENTITY OF A CARD HOLDER”, and which is incorporated herein by reference in it's entirely.

All of the above aforementioned patent application(s) are incorporated herein by reference in their entirety.

### BACKGROUND OF THE INVENTION

One type of fraud is where a person has unauthorized possession of a card, such as possession of a credit, access, license, credential and/or identification card, and employs the card to masquerade as another person who is an authorized holder (user) of the card. A typical credit, access and/or identification card does not include technology within it to accurately detect possession of the card by a person other than an authorized user of the card. The invention described herein addresses this type of problem.

The discussion above is merely provided for general background information and is not intended to be used as an aid in determining the scope of the claimed subject matter.

### BRIEF DESCRIPTION OF THE OF THE INVENTION

The invention provides system and apparatus for verifying an identity of a card holder. The system is designed for obtaining a geographically remote biometric scan of a card holder's fingerprint, and optionally for obtaining other actions from the card holder, as a condition for completing performance of a transaction in association with the card. The transaction may involve performance of actions of a financial nature, and/or may involve performance of actions for verifying proximity and/or location of a card holder, and/or for providing physical access to a secure facility, and/or for validating a license, permit or other type of credential.

### BRIEF DESCRIPTION OF THE DRAWINGS

It is to be noted, however, that the drawings illustrate only some embodiments of this invention and are therefore not to be considered limiting the scope of the invention, for the scope of the invention can encompass other embodiments consistent with the invention description herein.

The drawings are not necessarily to scale. The emphasis of the drawings is generally being placed upon illustrating the features of certain embodiments of the invention. In the drawings, like numerals are used to indicate like parts throughout the various views. Differences between like parts may cause those parts to be indicated with different numerals. Unlike parts are indicated with different numerals. Thus, for further understanding of the invention, reference can be made to the following detailed description, read in connection with the drawings in which:

FIG. 1 illustrates an embodiment of an identity verification system for a holder of a card that is currently engaged into a card reader, and where the holder is further in possession of one or more mobile telephone device(s).

FIG. 2 illustrates an embodiment of an identity verification system (FOB) device.

FIG. 3 illustrates an embodiment of an identity verification system for a holder of a card that is currently engaged into a card reader, and where the holder is not in possession of a mobile telephone device.

FIG. 4 illustrates an embodiment of an identity verification system for a holder of a card that is not currently engaged into a card reader, and where the holder is further in possession of a mobile telephone device.

FIG. 5 illustrates an embodiment of a smart card including a wireless transceiver chip.

FIG. 6 illustrates an embodiment of an identity verification system for participants of a health care provider organization.

FIG. 7 illustrates an embodiment of an identity verification system incorporating an enhanced mobile telephone device.

### DETAILED DESCRIPTION OF THE INVENTION

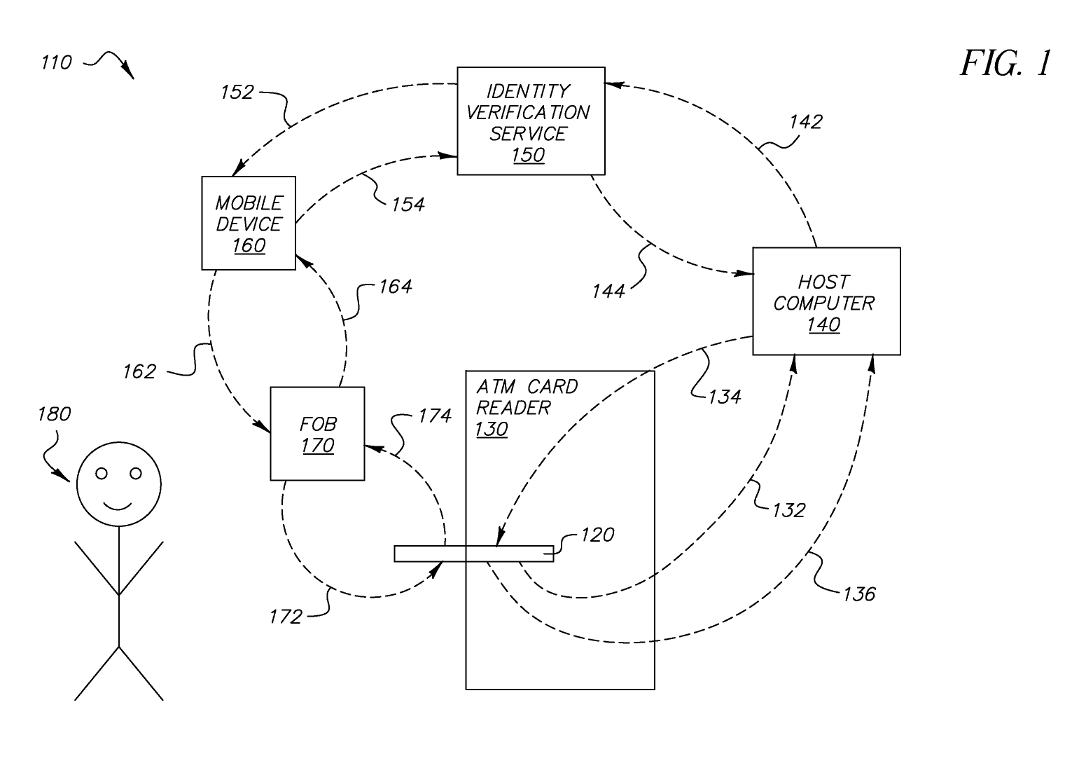

FIG. 1 illustrates an embodiment of an identity verification system 110 for a holder 180 of a card 120 that is currently engaged into a card reader 130, and where the holder 180 is further in possession of a mobile telephone device 160, also referred to herein as a mobile device 160. The holder 180 is also in possession of a portable biometric measurement device, also referred to herein as a (KEY FOB or FOB) device 170 that is designed to be used by the holder 180 of the card 120 and designed to interoperate and communicate with the card 120 and with an identity verification service (IVS).

The card 120 can be embodied as a portable object having a shape other than a card, and/or can function in many different ways, including as a financial instrument, such as a credit or debit card or function as an access card to a secure facility, for example. Within this exemplary embodiment, the card 120 is designed to be inserted into a card reader of an automated teller machine (ATM) 130 and functions as an ATM (access) card 120. While engaged into a card reader, the card 120 can be employed to perform one or more ATM transactions.

Be aware that the ATM machine 130 is just one example of a type of a card reader 130. In accordance with the subject matter of the invention, the invention is intended to apply to any type of card or portable object reader 130 and/or to any type of card or portable object 120 from which the card reader 130 (or object reader 130) is designed to read (extract information) from. In some embodiments, the card or object reader 130 is also designed to also write information to the card or portable object 120. Following, one or more embodiments of the invention as applied to an ATM card reader 130 and an ATM card 120 are described. Such ATM related embodiments of the invention are in no way intended to limit the scope of the types of card or portable object readers and/or types of cards and/or portable objects to which the invention is intended to apply.

As shown, the ATM card 120, also referred to herein as a card 120, is inserted into a card reading device of an ATM machine 130 by a holder (possessor) 180 of the ATM card 120. The card reading device makes electrical contact with the card 120 and reads at least a first identifier from the card 120. In this example use scenario, the first identifier uniquely identifies the card 120 itself and is released (output) by the card 120 via (through) the card reader 130. In this example scenario, this first identifier is assigned in accordance with procedures of a financial institution, such as of a banking institution that has issued the card 120. In other typical use scenarios, the card 120 provides information in addition to and/or other than that of the first identifier.

The ATM machine 130 is designed to interact with and to solicit and input other information from the holder 180 of the card 120 in response to insertion of the card into the ATM machine 130. The first (card) identifier and any other holder solicited information, such as a holder selected financial transaction type and holder selected a transaction amount information, which collectively constitute a first set of information that is transmitted from the ATM machine 130 to the host computer 140 via a communication 132.

In response to receiving the communication 132, the host computer 140 determines a second set of information, for example a second set of one or more identifiers in association with the first set of information including the first (card) identifier. In this example (exemplary) use scenario, this second set of information includes at least a card user identifier, and preferably at least one unique token or at least a portion of the token, in addition to at least the (first) card identifier of the first set of information.

The card user identifier, also referred to herein as a user identifier, identifies an authorized user of the card 120, where the user is authorized by the financial institution. The token is set of one or more data value(s) under protection of some form of confidentiality that is associated with the financial institution. In some use embodiments, at least a portion of the token uniquely identifies a financial account and/or authorized user associated with the card 120. In some use embodiments, at least a portion of the token can be equal to or include a random number and/or be equal to and/or include time variant data value, or be equal to and/or or include a time in variant (static) value.

In this example scenario, the user identifier uniquely identifies an authorized holder (user) of the ATM card 120 in association with the first (card) identifier. In this scenario, at least the second set of information, including namely the user identifier and optionally at least a portion of the token, are communicated from the host computer 140 to an identity verification service (IVS) 150 via a communication 142. The second set of information is designed to assist the IVS 150 with performing a nearly immediate contact with an authorized user of the card 120. The IVS 150 employs the second set of information to contact an authorized user (holder) of the card 120, in order to at least verify (test) the identity of the card holder at a current time of this current transaction, and in addition, to obtain approval of any financial transaction that is being performed in association with the card 120, if applicable, via communication 152.

In this exemplary use scenario, the communication 152 includes an identity verification request, which in this embodiment of the invention, is a request to the user to perform a finger swipe scan operation, and communication 152 includes a transaction approval request, which is a request for the user to indicate an approval of the current ATM transaction that is being attempted via the card 120. Like other communications, communication 152 is embodied as a communications transaction, also referred to herein as a communications packet, that is communicated to a mobile device 160 that is known to be in the possession of the user 180. The identity verification and transaction approval requests are communicated from the IVS 150 to a mobile device 160 via the communication 152, and these two requests are re-transmitted from the mobile device 160 to a biometric (FOB) device 170, via communication 162.

In this embodiment, the communications 152 and 162, each include information for facilitating communication with the biometric (FOB) device 170, the card 120 and the host computer 140. Such information is also referred to herein as communications associated information. The communications associated information is employed by the mobile device 160 to address and to communicate with the biometric (FOB) device 170, and ultimately the holder 180 of this device 170.

In normal circumstances, the holder 180 of this FOB device 170 would be an authorized user of the card 120. The communication associated information is also employed by the FOB device 170 to address and to encrypt any communication with the card 120, while the card 120 is inserted into the card reader of the ATM machine 130. The communication associated information is also employed by the card 120 to encrypt a communication 136 to the host computer 140.

This communication associated information includes wireless network addressing information that is associated with the FOB device 170, and the card 120. In this embodiment, Blue Tooth (Version 4.0) Low Energy technology is employed within the card 120 and within the FOB device 170. In this embodiment, the communication 152, 162, 172 includes Bluetooth address information for the FOB device 170 and the Bluetooth address information for the card 120. A Bluetooth 4.0 address is expressed as a 48 bit value. In some embodiments, the FOB device 170 has previously been Blue Tooth paired with the card 120, prior to communication between the Biometric FOB device 170 and the card 120.

In other embodiments, other wireless protocols can be employed for communication involving the FOB device 170 and/or the card 120 and/or the mobile device 160, in addition to or in combination with, or as a substitute for the Bluetooth wireless protocol. These wireless protocols can include, but are not limited to, WiFi, ZigBee, RFID and/or NFC, for example.

In some embodiments, the mobile device 160 is an Android™ Smart Phone or Apple IPhone™. In some embodiments, a SIM card within the mobile device 160 is employed to store communication associated information for communication with the FOB device 170. Optionally, in some embodiments, text can be communicated to and displayed onto the mobile device 160 to inform the holder 180 of one or more actions that are being requested of the holder 180 to perform in association with the FOB device 170. Optionally, the holder 180 can respond to text that is displayed onto the mobile device 160.

In response to receiving communication 162, the FOB device 170 notifies its holder 180 via a vibration, and/or an auditory signal and/or a visual signal, of the occurrence of receiving communication 162. The communication 162 includes a request for the holder 180 to perform a fingerprint biometric scan operation (identity verification request) and a request for the holder 180 to indicate transaction approval (transaction approval request).

Optionally, the FOB device 170 also displays text onto a display screen of the FOB device 170 regarding the request for performing a fingerprint scan operation and regarding the request for transaction approval, and prompts the holder (possessor) 180 of the FOB device 170 to perform a finger swipe scan operation. In response to the holder 180 performing a finger swipe via the FOB device 170, the FOB device 170 then performs a finger swipe scan matching procedure. Optionally, in some embodiments, the prompting of the holder 180 via screen displayed text is displayed onto a display screen of the mobile device 160.

Upon determination of a successful match in combination with an indication of approval or disapproval of the transaction, or upon determination of a failed match, a communication 172a, or a communication 172b, or a communication 172c, which are also collectively referred to herein as communication 172, are each employed (transmitted) to indicate biometric match success and transaction approval 172a or biometric match success and transaction non-approval 172b, or else biometric match failure 172c, in association with the holder 180 of the FOB device 170. Communications 172a-172c are each respectively transmitted from the FOB device 170 to the card 120. In this exemplary use scenario, each of the type of communication 172, which is collectively communications 172a-172c, includes the same secure token or portion of the token that was originally transmitted from the host computer 140 within communication 142 to the IVS 150.

Communication 172a is referred to herein as a biometric approval communication that is transmitted from the biometric FOB device 170 to the card 120, and indicates both a successful biometric finger print match by the holder 180 and indicates approval of the current transaction by the holder 180. This communication 172a was sent by the biometric FOB device 170 in response to this device 170 receiving communication 162 from the mobile device 160, which was relayed by the mobile device 160 upon receiving communication 152, that was sent by the identity verification service (IVS) 150 to the mobile device 160.

The content of the communication 172a or 172b or 172c is re-transmitted from the card 120 to the host computer 140 via a communication 136. Upon receiving one of the communication(s) 172, as either communication 172a or communication 172b or communication 172c, the card 120 re-transmits communication 172 to the host computer 140 via communication 136. The communication 172 and communication 136 includes (releases) the secure token or portion of the token that was originally transmitted by the host computer 140 to the IVS 150. Including the secure token enables the host computer 140 to track and associate (pair) any received communications 136 from the card 120 with each individual prior transmitted communications 142 from the host computer 140 to the IVS 150.

Upon transmitting the communication 136, the card 120 preferably transmits an acknowledgment or non-acknowledgement indication to the FOB device 170 that the communication 136 was transmitted, via transmission of communication 174. Upon receiving communication 174, the FOB device 170 preferably transmits its own acknowledgment or non-acknowledgement that also incorporates the acknowledgement or non-acknowledgement indication of communication 174, via transmission of communication 164 to the mobile device 160. Upon receiving communication 164, the mobile device 160 preferably transmits its own acknowledgment or non-acknowledgement indication that incorporates the content of communication 164 and communication 174, to the identity verification service (IVS) 150 via communication 154.

Optionally, prompt transmission of individual acknowledgements or non-acknowledgements in association with receiving or attempting to receive any individual communication transmission, such as receiving communications 132, 142, 152, 162, 172, can be performed, by the host computer 140, IVS 150, mobile device 160, FOB device 170 or the card 120, respectively. However, one or more lower level communication protocols that are employed to carry such communications 132, 142, 152, 162, 172 as are shown in FIG. 1 for example, may by default to be inherently designed to perform such prompt transmission of individual acknowledgements or non-acknowledgements, in direct response to receiving communications 132, 142, 152, 162, 172, for example.

If no acknowledgment or non-acknowledgement indication communication 154 is received by the IVS 150 from the card 120, and/or nor any other type of communication indicating receipt of communication 152 by the mobile device 160, within a time period of pre-determined length, for example a length equal to two minutes, then communication 144 includes an indication to the host computer 140 that a time out condition has occurred. A time out condition indicates that the mobile device 160 and/or the FOB device 170 and/or the card 120 may not be currently operational, or that the FOB device 170 is not in possession of the card holder 180, or that a prompt from the FOB 170 was not responded to by anyone, and/or that the card 120 is in the possession of someone other than the holder 180 and who is not an authorized user the card 120.

Distance range limitations of the wireless communication technology employed by the card 120 and by the FOB device 170, indicate that if the card 120 responds with a communication 174, then the card 120, that is inserted within the card reader of the ATM machine 130, is within some quantifiable physical proximity of the FOB device 170. For Bluetooth low energy embodiments, this distance range limitation should be approximately 50 meters or less, depending upon the physical environment between the card 120 and the FOB device 170.

If the FOB device 170 transmits communication 172a or 172b to the card 120 and the content of such communication is transmitted to the host computer 140 by the card 120, then it can be inferred that it is likely that an authorized user is located in physical proximity to the card 120, while the card 120 is being currently used. Else if, the FOB device 170 transmits communication 172c, then it can be inferred that a likely un-authorized user of the card 120 is located in physical proximity to the card 120, while the card 120 is being attempted to be used for performing the current transaction.

In accordance with the invention, any communication including a secure token or a portion of the token is communicated in a secure manner. In one embodiment, the secure manner employs public key infrastructure (PKI) methodology. In this embodiment, the IVS 150, the FOB device 170, the card 120 and the host computer 140 are each assigned a unique pair of encryption keys. Each pair of encryption keys includes a public encryption key and a private encryption key. Details of how PKI methodology is applied to the above described system are further described at the end of this document.

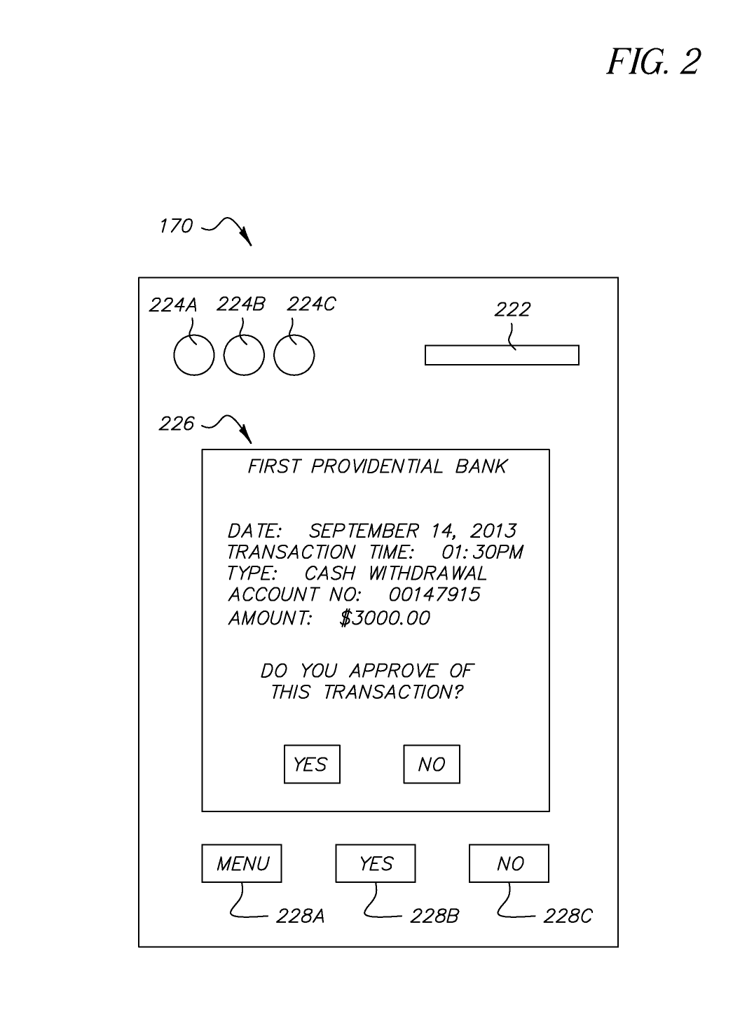

FIG. 2 illustrates an embodiment of an identity verification system biometric FOB device 170. As shown, the FOB device 170, also referred to herein as the biometric device 170 or device 170, includes a biometric finger swipe scan sensor 222, a set of status indicator lights 224a-224c, a user interface display screen 226 and a set of control buttons 228a-228c. In some embodiments, the biometric finger swipe scan sensor 222 is designed based upon sensing acoustic impedance, however other finger swipe or finger touch sensors employing acoustic or of other technologies, such as employing sensing electrical capacitance, can be employed as the sensor 222 and incorporated into this FOB device 170.

In response to receiving an identity verification request and/or a receiving a transaction approval request, for example, via communication 152 that is re-transmitted as communication 162, the FOB device 170 notifies its holder via vibration, an auditory signal and/or a visual signal, of the occurrence of receiving the communication 162. This communication prompts the holder 180 of the device 170 for performance of a finger print swipe scan operation.

To notify the holder 180, the FOB device 170 displays text onto a display screen of the FOB device 170 regarding the identity verification request and the transaction approval request, and prompts the holder (possessor) of the FOB device 170, via flashing of status lights 224a-224c to perform a finger swipe scan operation, that prompts the holder of the device 170 to make physical contact using a finger of the holder and with a biometric sensor 222 of the FOB device 170, in order to capture a digitally encoded scan of a finger print pattern of the finger of the holder (See FIG. 2) Optionally, in other embodiments, the above described text is also displayed or only displayed onto a display screen of the mobile device 160.

The finger swipe scan operation is performed by a holder of the device 170, by making physical contact between the holder's index finger and a biometric sensor (finger swipe) portion of the FOB device 170 (See FIG. 2). In response to performing a finger swipe scan operation, the FOB device 170 performs a matching procedure between a finger swipe template of any authorized user of the FOB device 170 that is pre-stored within the device 170, and finger swipe data currently being obtained via a scanning operation performed by the FOB device 170. The finger swipe template(s) of any authorized user is stored within non-volatile memory of the FOB device 170, prior to the performance of the finger swipe operation by the holder of the FOB device 170. The finger swipe data captured via the finger swipe operation performed by the holder (possessor) of the device 170 is digitally scanned by and input into the FOB device 170, and processed by the device 170.

If the FOB device 170 determines that a successful finger print pattern match has occurred, the FOB device holder 180 is prompted via screen displayed text to approve a transaction that is currently being performed with the card 120. As shown in this embodiment, the FOB device 170 includes a visual display screen (See FIG. 2) that displays a textual and/or graphic transaction description of the financial institution “First Providential Bank”, the account number “00147915”, transaction type “Cash Withdrawal”, and a transaction amount “3000.00” to the FOB device holder (possessor) 180. The text also indicates date and time information. The FOB device 170 also includes a user input mechanism, buttons 228a-228c or a virtual buttons 226a-226b that are displayed onto the visual display touch screen, for the user to indicate approval or disapproval of the transaction. A menu labeled button 228a, enables the holder to access other functions of the device 170.

If the FOB device 170 determines that a successful finger print pattern match has not occurred, the holder is re-prompted and asked to perform an additional finger swipe scan operation. If a successful match cannot be achieved within a limited number (series) of finger swipe scan operation attempts, then communication 172c, indicating a failed match result, is transmitted from the FOB device 170 to the card 120.

Upon the FOB device 170 indicting to a holder of a failed match result 172c, or indicating a successful match in combination with approval 172a or disapproval 172b of the transaction, one of such respective communications 172a-172c is transmitted from the FOB device 170 to the card 120, in association with the current holder of the FOB device 170. The content of the communication 172a or 172b or 172c is re-transmitted from the card 120 to the host computer 140 via a communication 136.

To address circumstances where holder 180 of the card is being forced to use the card 120 under duress, an embodiment of the FOB device 170 is designed to detect and distinguish a middle fingerprint scan from an index finger print scan, and can communicate detection of a middle finger print scan to the host computer.

In other embodiments, the FOB device 170 does not include a touch screen and responses are indicated by the holder 180 via pressing of physical buttons 228a-228c. In other embodiments, the FOB device 170 does not include a text or graphic display screen, and responses are indicated by the holder 180 via pressing of physical buttons 228b-228c. Without a display screen, the system can employ text display and response functions of the mobile device 160 to supplement such functions lacking within the display screen less embodiment of the FOB device 170.

Also, some embodiments of the FOB device 170 employ other than a biometric fingerprint scan. For example, the FOB device could employ measurement of a biometric other than that of a fingerprint, or instead employ a non-biometric measurement and prompt the user with security questions and/or prompt for a password, for example.

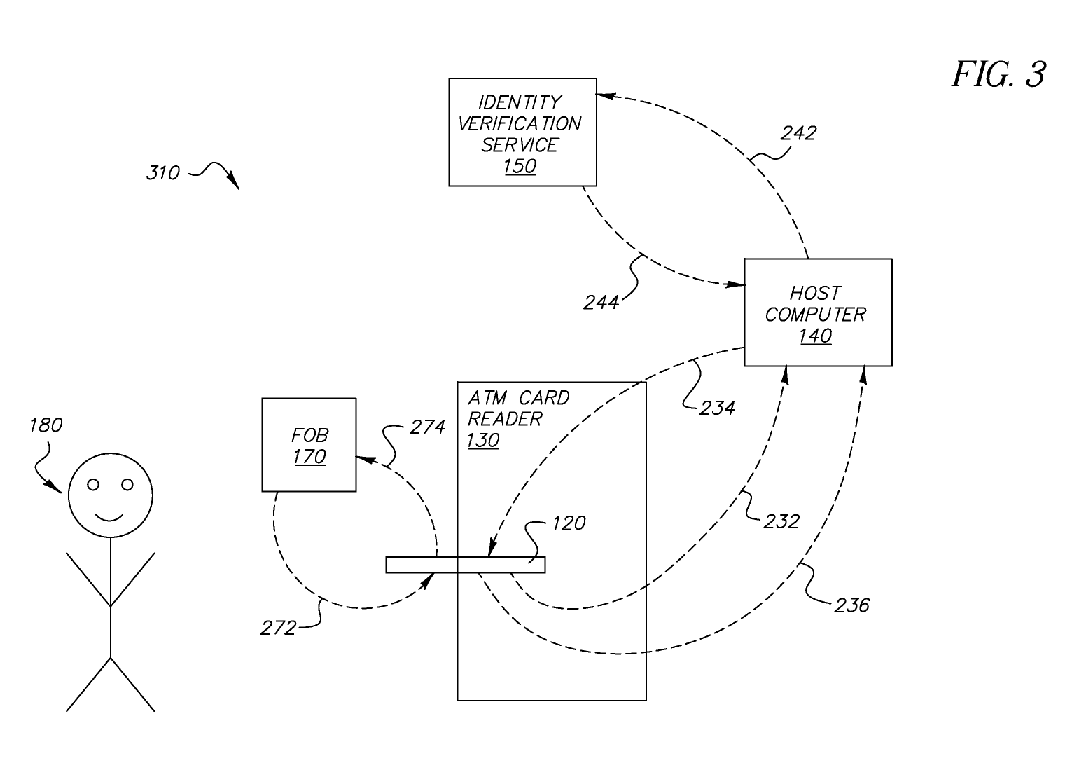

FIG. 3 illustrates another embodiment of an identity verification system 310 for a holder 180 of an automated teller machine (ATM) card 120 who is without possession of a mobile telephone device. As shown, a first portion of this embodiment of the system is designed like that described for FIG. 1, and a second portion of this embodiment is designed unlike that described in FIG. 1. The first portion of this embodiment, includes communication 232, 236 and 242 which each function like communications 132, 136 and 142 respectively of FIG. 1. However, the second portion of this embodiment includes communications 234, 244 and 274 which each function differently than communications 144, 134 and 174 respectively of FIG. 1.

The communication 232 functions like communication 132 of FIG. 1. The communication 242 functions like communication 142 of FIG. 1. Like the embodiment of FIG. 1, in response to receiving communication 232, the host computer 140 transmits communication 242 to the identity verification service (IVS) 150 in the same manner described for communication 142 of FIG. 1. However, because the authorized user does not have a mobile device that is registered with the IVS 150, the IVS 150 will instead transmit a communication that will be relayed to the FOB device 170 via the host computer 140 and the card 120, instead of via a mobile device.

The IVS 150 employs the second set of information of communication 242 to contact the FOB device 170, via communication 244 which functions similar, but not identical, to communication 152 of FIG. 1. Instead, of the IVS 150 directing a communication 152 to a mobile device (See FIG. 1), the IVS 150 directs the communication 244 back to the host computer 140. The host computer 140 relays communication 244 by transmitting communication 234 to the card 120. The card 120 relays communication 234 to the FOB device 170.

The communication 244 and 234 include content like that of communication 152, and at least some of the content is encrypted in the public key of the FOB device 170. The content includes an identity verification request and a transaction approval request, and communication associated information like described in association with FIG. 1, and the Bluetooth address of the FOB device that is employed by the card 120 to transmit communication 274 to the FOB device 170.

Like described in association with FIG. 1, in response to receiving communication 274, the FOB device 170 notifies its holder via vibration, an auditory signal and/or a visual signal, of the occurrence of receiving communication 274, displays text onto a display screen of the FOB device 170 regarding the request for financial transaction approval, and prompts the holder (possessor) of the FOB device 170 to perform a finger swipe scan operation and then performs a finger swipe scan matching procedure.

Upon indicating a successful match in combination with approval or disapproval of the transaction, or upon indicating a failed match, a communication 272a (biometric match with transaction approval) or communication 272b (biometric match without transaction approval), or communication 272c (no biometric match) respectively, which are also collectively referred to herein as communication 272, are respectively transmitted by the FOB device 170 to the card 120 to indicate a biometric match success and transaction approval 272a, or biometric match success and transaction non-approval 272b, or else to indicate a biometric match failure 272c, in association with the holder of the FOB device 170.

The content of the communication 272, namely either communication 272a or 272b or 272c, includes the token or the portion of the token originally transmitted within communication 242, and is re-transmitted from the card 120 to the host computer 140 via a communication 236. Including the secure token enables the host computer 140 to track and associated any received communications 136 from the card 120 with each individual and prior transmitted communications 242 from the host computer 140 to the IVS 150.

To address circumstances where holder 180 of the card is being forced to use the card 120 under duress, an embodiment of the FOB device 170 is designed to detect and distinguish a middle fingerprint scan from an index finger print scan, and can communicate detection of a middle finger print scan to the host computer.

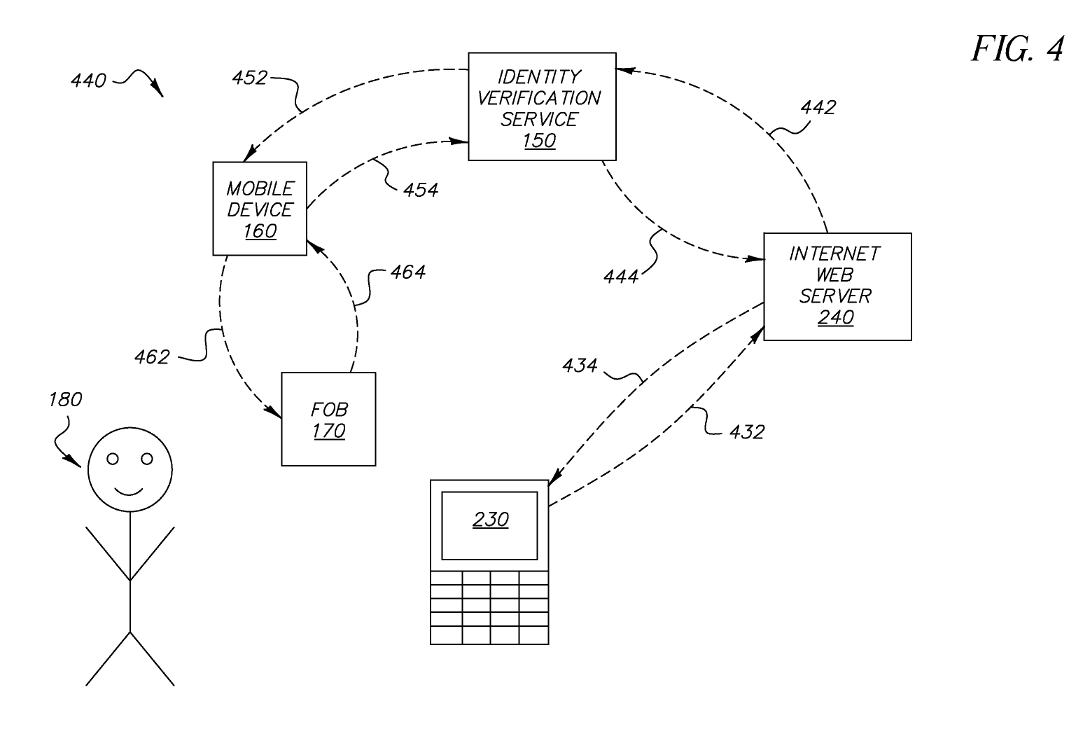

FIG. 4 illustrates an embodiment of an identity verification system 410 for a holder of a card that is not engaged into a card reader, and where the holder 180 is further in possession of a mobile telephone device 160. This type of embodiment can be employed, for example, when a card holder is using a card to perform a financial transaction, such as to perform a purchase, via a computer network or telephone, or via a card swiping operation within a card swipe machine, as opposed to inserting the card into a card reader.

As shown, a first portion of this embodiment of the system is designed like that described for FIG. 1 and a second portion of this embodiment is designed not like that described in FIG. 1. The first portion of this embodiment, namely communication between the IVS 150, the mobile device 160 and the FOB device 170, is like that described in association with FIG. 1. The second portion of this embodiment lacks a card reading device and an ATM machine, and instead employs a computer to make a purchase from an Internet accessible Web server.

In this exemplary embodiment, an item purchase via a computer network using a credit or debit card is performed. Credit or debit card information is transmitted from a computer 230 to a network accessible Web server 240. The Web server 240 converts the credit or debit card information, into a second set of information, including an authorized user identifier, for inclusion into communication 442 to the IVS 150, like that described for communication 142 of FIG. 1.

Like described in association with FIG. 1, the IVS 150 employs the second set of information of communication 442 to contact the FOB device 170, via communication 452 which functions like communication 152 of FIG. 1. Like communication 152 of FIG. 1, communication 452 is communicated to a mobile device 160 and relayed by the mobile device 160 to the FOB device 170 via transmission of communication 462.

The FOB device 170 operates in a manner like that described in FIG. 1, and the FOB device 170 transmits its response 464 to the identity verification request and transaction approval request communication 462, with content like the communication(s) 172 of FIG. 1, instead back to the mobile device 160 and not to a card. In this embodiment, no smart card with communication electronics is required for delivery of a response communication from the FOB device 170.

Upon indicating a successful biometric match in combination with transaction approval 464a, or transaction disapproval 464b, or upon indicating a failed match 464c, a communication 464a or communication 464b, or communication 464c respectively, which are also collectively referred to herein as communication 464, are transmitted (employed) by the FOB device 170 to indicate a biometric match success and transaction approval 464a or transaction non-approval 464b, or else to indicate a biometric match failure 464c, in association with the holder of the FOB device 170, is respectively transmitted from the FOB device 170 to the mobile device 160.

The content of the communication 464, namely either communication 464a or 464b or 464c, each including the token or a portion of the token originally transmitted within communication 442, is re-transmitted from the mobile computer 160 to the IVS 150 via a communication 454. The IVS 150 relays communication 454 and re-transmits it as communication 444 to the Web Server 240. Including the secure token or a portion of the token within these communications 464, 454, 444 enables the Web server 240 to track and associate any received communications 444 from the IVS 150 with each individual prior transmitted communication 442 from the Web server 240 to the IVS 150.

In circumstances when using the card 120 for purchasing services at a restaurant, for example, transaction approval can also include display of text that enables the holder 180 to specify a gratuity amount in addition to a base transaction amount. In some embodiments, the FOB device 170 includes both a touch screen and a virtual keypad that is accessed via the Menu button 228a for which the holder can employ to specify such a gratuity amount. In some embodiments, a sales receipt, including the gratuity amount, can be printed from the FOB device 170, and an associated printing communication can be optionally relayed through the mobile device 160, to a wireless printer.

Optionally, the mobile device 160 can provide an alternative means to the FOB device 170, for prompting performance of a finger print scan swipe. This option is especially helpful when using a less functioned embodiment of the FOB device 170. For example, a less functioned embodiment of the FOB device 170, could lack a display screen and communicate with the holder 180 via flashing lights that prompt for performance of a finger print scan swipe operation, without having the capability to display text to prompt for and finger print scan and/or transaction approval. This less functioned embodiment of the FOB 170 would also be effective when using the FOB device 170 for access into a secure facility, either when in communication with a card 120 (FIGS. 1 and 3), or when not in communication with the card (FIG. 4), and where a successful fingerprint scan operation would be sufficient to satisfy a pre-condition for access to a secure facility.

In some use scenarios, a person who is authorized to be a holder of a card and a person who is authorized to approve a transaction that is performed in association with the card, may not be the same person. For example, a parent may provide a credit card to a child, where all transactions over a pre-determined amount, are subject to the approval of the parent, who may not be located in proximity to a performance of a transaction using the card.

This system 410 would enable the parent, who may not be located in proximity (50 meters) from a location where the child is using the card, to be informed of the performance and amount of the transaction that is currently being performed, prior to approving or not approving the transaction. A similar use scenario can be employed for an employer/employee arrangement, where the employee is an authorized holder of a card and an employer is an authorized approver of transactions that are performed in association with the card. Optionally, the above described use scenarios, and other described scenarios in this document, can in some circumstances, be implemented with or without additionally requiring a biometric fingerprint scan measurement from the holder of the biometric device, where an institution may simply want to verify proximity from the FOB device 170 relative to the mobile device 160 and/or the card 120

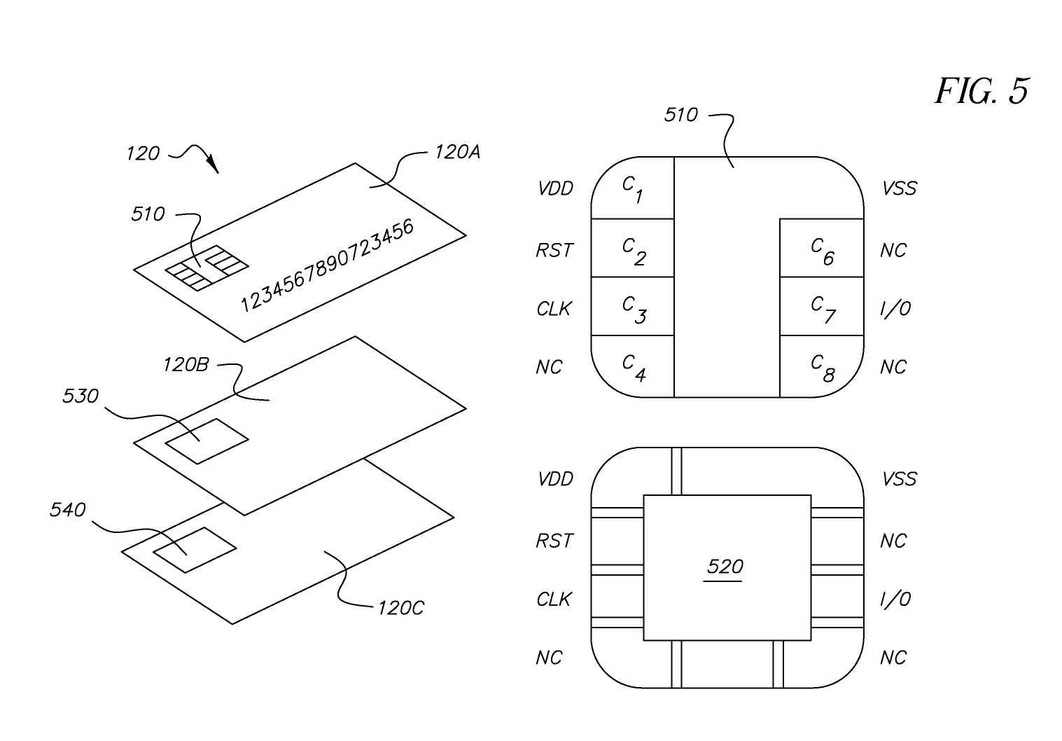

FIG. 5 illustrates an embodiment of a smart 120 card including a wireless transceiver chip. As shown, an upper side of a top layer 120a of the smart card 120 includes an electrical contact pad 510. In this embodiment, the electrical contact pad 510, which is also referred to herein as the contact pad 510, is designed in accordance with an International Standards Organization (ISO) 7816 standard. The top layer 120a of this card 120 is also designed so that the contact pad 510 is exposed outside of the top layer 120a of the card 120 (as shown here), and is also exposed on a lower side (not shown here) of the top layer 120a of the card 120.

A lower layer 120b of the card 120 includes an aperture (void) 530 within which an integrated circuit chip device 520 is designed to reside and function within the smart card 120. In this embodiment, the integrated circuit chip device 520 is a one chip design that includes a variety of electronic circuitry, including such as a Bluetooth wireless transceiver, electronic circuitry implementing ISO 7816 T0 & T1 communications protocol stack functionality, an antenna and memory.

When located within this aperture 530, the integrated circuit chip device 520, also referred to herein as the IC 520, is designed to make direct electrical contact with a lower side (not shown here) of the contact pad 510 that resides within the top layer 120a of the smart card 120. The IC device 520 includes electrical contacts VDD, RSR, CLK, NC, VSS, NC, I/O and NC which physical and electrically match with the respective electrical contacts VDD, RSR, CLK, NC, VSS, NC, I/O and NC of the contact pad 510. Such a direct electrical contact design simplifies manufacturing of the card 120. Furthermore, this design is currently compatible with many known hot laminate smart card manufacturing facilities.

A bottom layer 120c of the smart card 120 includes a protective layer 540 for protection of internal components of the card 120, including the one chip IC device 520. In some embodiments, the bottom layer 120c may also have a recess comprising an antenna for communications.

Referring back to FIG. 1, in accordance with the invention, any communication including a secure token or a portion of the token, is communicated in a secure manner. In one embodiment, the secure manner employs public key infrastructure (PKI) methodology. In this embodiment, the IVS 150, the FOB device 170, the card 120 and the host computer 140 are each assigned a unique pair of encryption keys. Each pair of encryption keys includes a public encryption key and a private encryption key.

In one embodiment, at least a portion of the content of the communication 152 that is transmitted from the IVS 150 to the mobile device 160 and transmitted as communication 162 from the mobile device to the FOB device 170, is encrypted as follows. The content of the communication 152 is encrypted by the IVS 150 using the public key of the FOB device 170 in combination with an RSA encryption algorithm. Further, the IVS 150 generates and adds a digital signature to the communication 152 using the private key assigned to the IVS 150. Likewise, communication 162 includes the encrypted content and the digital signature of communication 152.

In some embodiments, communication 152 further includes communication information that is processed by software executing on the mobile device 160 to facilitate the mobile device 160 establishing a communications connection (channel) with the FOB device 170, such as via the Bluetooth protocol. In other embodiments, the software executing on the mobile device 160 is pre-configured with such communication information regarding communication with the FOB device 170.

Upon receiving the encrypted communication 162 from the IVS 150 via the mobile device 160, the FOB device 170 decrypts the digital signature using the public key of the IVS 150 to verify that the content of the communication 162 was digitally signed by the IVS 150. The FOB device 170 also decrypts the content of the communication 162 using an RSA decryption algorithm that corresponds to the RSA encryption algorithm that was employed by the IVS 150 to encrypt the content, and using in combination the private key assigned to the FOB device 170.

The content of the communication 172 that is transmitted from the FOB device 170 to the card 120, is encrypted as follows. The content of the communication 172 is encrypted by the FOB device 170 using the public key of the card 120 in combination with an RSA encryption algorithm. Further, the FOB device 170 generates and adds a digital signature to the communication 172 using the private key assigned to the FOB device 170.

Upon receiving the encrypted communication 172 from the FOB device 170, the card 120 decrypts the digital signature using the public key of the FOB device 170 to verify that the communication 172 was digitally signed by the FOB device 170. The card 120 also decrypts the content of the communication 172 using an RSA decryption algorithm that corresponds to the RSA encryption algorithm that was employed by the FOB device 170 to encrypt the content, and using in combination the private key assigned to the card 120.

Upon verifying the integrity of the content of the communication 172, including the decrypted secure token or a portion of the token, the card 120 in preparation for transmitting communication 136, encrypts the decrypted content of the communication 172, including the decrypted token, using the RSA encryption algorithm and the public key assigned to the host computer 140. Further, the card 120 generates and adds a digital signature to the communication 166 using the private key assigned to the card 120.

Upon receiving the encrypted and signed communication 136 from the card 120, the host computer 140 decrypts the digital signature using the public key of the card 120 to verify that the communication 136 was digitally signed by the card 120. The host computer 140 also decrypts the content of the communication 136 using the RSA decryption algorithm that corresponds to the RSA encryption algorithm that was employed by the card 120 to encrypt the content, and using in combination the private key assigned to the host computer 140. Upon verifying the integrity of the content of the communication 136, including the decrypted token or portion of the token, the host computer 140 has in its possession information that it can employ to either complete or to not complete (abort) performance of the transaction associated with the current use of the card 120.

Upon verifying the integrity of the content of the communication 136, including the value of the decrypted token or portion of the token, if the communication 136 indicates approval of the transaction currently in progress, then the host computer 140 completes the transaction currently in progress that is associated with the card 120. Otherwise, the host computer 140 decides to not complete (abort) performance of the current transaction.

In support of the above described embodiment employing public key encryption (PKI) methodology, the communications 142, 152 also have the following supporting characteristics. The communication 142 from the host computer 140 includes, in addition to other previously described information, the public encryption key of the host computer 140.

The IVS 150 also includes the public encryption key it received from the host computer 140 into the content of the communication 152, the public encryption key of the FOB device 170 and the public encryption key of the card 120, into the content of communication 152, in addition to that which has been previously been described as being transmitted from the IVS 150 to the mobile device 160. The content of the communication 162 from the mobile device 160 to the FOB device 170 also includes the content of communication 152, which includes at least the aforementioned public encryption keys. The content of the communication 172 from the FOB device 170 also includes the content of communication 152, which includes at least the aforementioned public encryption keys. In some embodiments, as described earlier, at least a portion of the content of the communication 152 and of communication 162 is encrypted by the IVS 150 via the public key of the FOB device 170.

In some embodiments, the IVS 150 is implemented via a Data Distribution Service (DDS), which provides compatibility with multiple and different brands of financial transaction cards. In some embodiments, Representative State Transfer (RESTful) applications interface is also employed in combination with DDS. Optionally, JavaScript Object Notation (JSON is also employed within the IVS 150.

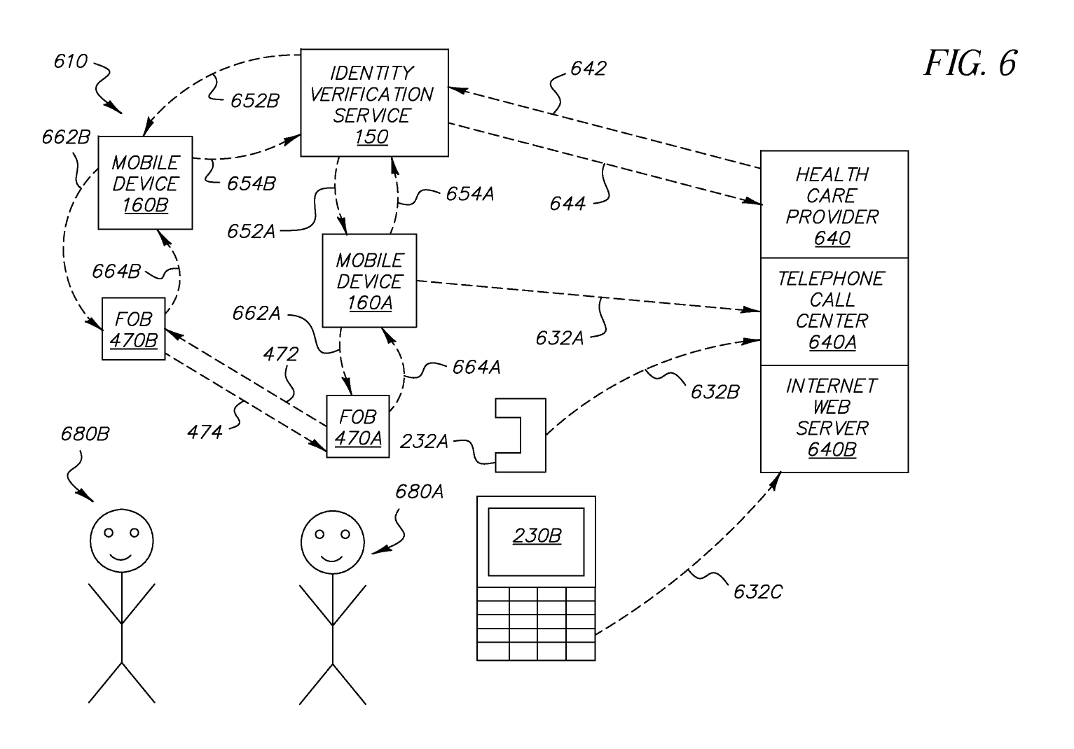

FIG. 6 illustrates an embodiment of an identity verification system 610 for participants associated with a health care provider organization. Typically, each participant is either a recipient or a provider of health care. Each participant is in possession of a health care participant identification card which identifies each participant via a participant identification number and a participant type code.

In the scenario shown here, participant 680a is a health care provider and participant 680b is a health care recipient. The participant 680a is located within the residence of participant 680b and is providing health care services to the health care recipient 680b. These health care services may include dispensing of medicine, measurement of physiological parameters and/or providing of a meal to the health care recipient 680b, also referred to herein as a patient. The health care providing company encourages and/or requires that this health care providing session be reported to the health care providing company proximate to the time and place of its occurrence.

In one embodiment, to accomplish this reporting, the health care provider 680a places a telephone call communication 632a-632b via telephone 232A to a telephone call center of the health care provider organization to report that a health care providing session is in progress, between the provider 680a and the recipient 680b. The telephone call center provides automated interaction with the provider 680a and solicits the participant identifier value of both the provider 680a and of the recipient 680b, and may solicit other related information from the provider 680a. The solicited information constitutes a first set of information like that described in FIG. 1.

In other use scenarios, reporting of a health care providing session can be instead initiated via access 632c to an Internet Web server 640b from a computer 230b. In yet other embodiments, a mobile device 160a-160b can be programmed with a software application that provides a graphical user interface including a menu to the holder 680a-680b of the device 160a-160b that enables a holder of the device to initiate reporting of a health care providing session to the health care providing organization.

The telephone call center 640a employs a host computer system, like the host computer 140 of FIG. 1, for performing the automated telephone interaction with the provider 680a and for performing transmission to, and reception of digital communications from, outside entities, such as to and from the identity verification service (IVS) 150.

In response to receiving the communication 632a or 632b, the host computer system determines a second set of information, in association with the first set of information provided via the automated telephone interaction. At the least one of the first and second set of information includes the participant identifier information. Each participant identifier value identifies an authorized holder of a health care benefit card that is authorized by the health care providing organization.

In this use scenario, at least the second set of information, is communicated from the host computer to the identity verification service (IVS) 150 via a communication 642. The second set of information is designed to assist with performing a nearly immediate contact with both of the participants 680a-680b of this health care providing session. The IVS 150 employs the second set of information to contact the participant 680a via communication 652a in order to at least verify (test) the identity of the participant 680a at a current time of this current transaction.

In this exemplary use scenario, the communication 652a includes a request to perform a finger print scan operation and a request to verify proximity of another participant, which is specifically the proximity of the health care recipient 680b relative to health care provider 680a. Both of these requests are embodied within the information content of communication 652a, within a communications packet, and are not necessarily performed in the above recited order. The communications packet is also referred to herein as a communications transaction. These two requests are communicated from the IVS 150 to a mobile device 160a via the communication 652a, and are re-transmitted by and from the mobile device 160a to an FOB device 470a, which is also referred to herein as a key fob or FOB 470a, via communication 662a. The FOB device 470a is currently in possession of the health care provider participant 680a.

In this embodiment, the communications 652a and 662a each include communication associated information for the FOB device 470a. The communication associated information is employed by the IVS 150 to address and communicate with the mobile device 160a, and is employed by the mobile device 160a to address and to communicate with the FOB device 470a, and ultimately the holder 680a of this device 470a, as described in association with FIGS. 1-5. The communications associated information also includes public key infrastructure (PKI) codes for encryption and decryption, where applicable.

In normal circumstances, the holder 680a of this device 470a would be a participant who is authorized by the health care provider organization to provide health care services to the recipient 680a. The communication associated information is also employed by the FOB device 470a to address and to communicate with the device 470b, and employed by device 470b to address and to communicate with device 470a, and to perform encryption and decryption where applicable.

In this embodiment, the communication associated information includes communication protocol related information, such as short message service (SMS) and Bluetooth (Version 4.0) low energy technology associated information, as explained in association with FIG. 1. In other embodiments, wireless protocols other than Bluetooth such as WiFi, ZigBee, RFID and/or NFC, can be employed, and other data carrying protocols, in combination with or as an alternative to SMS, can be employed, for example. For example, the simple mail transfer protocol (SMTP) can be employed as a means for communication with software residing on the mobile device 160.

Like described in association with FIGS. 1-5, in some embodiments, the mobile device 160 is a smart phone, such as an Android Smart Phone or Apple IPhone. A SIM card that is within an embodiment the mobile device 160 is employed to store communication associated information that is employed for communication with the FOB device 470a-470b. Optionally, in some embodiments, text can be communicated to and displayed onto the mobile device 160a-160b to inform the holder 680a-680b of one or more operations that are being requested of the holder 680a-680b to perform on the FOB device 470a-470b. Optionally, the holder 680a-680b can respond to text that is displayed onto the mobile device 160.

In response to receiving communication 662a, the FOB device 470a notifies its holder via a vibration, and/or an auditory signal and/or a visual signal, of the occurrence of receiving communication 662a. The communication 662a includes a request to perform a fingerprint scan operation and a request to verify a proximity of another participant. Optionally, the FOB device 470a also displays text onto a display screen of the FOB device 470a regarding the request for performing a fingerprint scan operation and regarding the request to verify a proximity of another participant.

The device 470a prompts the holder (possessor) 680a of the FOB device 470a to perform a finger swipe scan operation. In response, the holder 680a of the FOB device 470a then performs a finger swipe action and the FOB device 470a performs a fingerprint scan matching procedure in response to the finger swipe action. Optionally, in some embodiments, the above described text that is displayed onto the device 470a is instead displayed, or also displayed onto a display screen of the mobile device 160a.

The device 470a also transmits a wireless communication 472 to device 470b to verify the proximity of the device 470b and to request to perform a finger print scan operation from the holder 680b of the device 470b. The device 470b responds to the request to perform a finger print scan operation in the same manner as described for the device 470a. The device 470b reports the result of the finger print scan operation back to the device 470a via communication 474. Receipt of communication 474 from device 470b by device 470a successfully verifies proximity of the devices 470a-470b. The device 470a reports the results of the finger print scan operation performed on device 470a, and reports the results of the finger print scan operation performed on device 470b, and reports the results of the request to verify proximity of another participant, via transmission of communication 664a.

Upon a result indicating a successful fingerprint scan match for both devices 470a-470b, or upon a result indicating a lack of proximity between devices 470a-470b and/or indicating a failed fingerprint scan match for at least one of devices 470-470b, a communication 664a is transmitted from the device 470a to the mobile device 160a, to communicate the result to the mobile device 160a. The communication 664a, includes any secure token or portion of the token that may have been originally transmitted within communication 642, from the health care provider organization 640.

The content of the communication 664a is re-transmitted from the mobile device 160a to the IVS 150. Upon receiving the communication 654a, the IVS 150 re-transmits the content of communication 654a to the health care provider organization 640 via communication 644.

The communication 644 functions as a response to communication 642. If no response communication 654a is received by the IVS 150, within a time period of pre-determined length, for example a length equal to five minutes, then communication 644 includes an indication to the host computer 140 that a time out condition has occurred. The time out condition detected by the IVS 150 indicates that the mobile device 160a and/or the FOB device 470A may not be currently operational, and/or or that a sensory prompt from the FOB 470a was not responded to by its holder 680a, and/or that the FOB device 470a is not in possession of the participant 680a and/or that the FOB 470a is in the possession of someone who is not an authorized participant.

If a secure token or any portion of the token was included within the communication 642, then communication 644 also includes the secure token or portion thereof that was originally transmitted by the health care provider 640 via communication 642. Including the secure token or portion thereof enables the health care provider 640 to track and associate any received communications 644 from the IVS 150 with each individual prior transmitted communications 642 from the health care provider to the IVS 150.

In alternative use scenarios, the IVS 150 can contact participant 680B via FOB device 470B in the same manner as described when the IVS 150 contacted the participant 680A via the FOB device 47Aa. In this use scenario, the communications 652B and 654B in association with FOB device 470B, function respectively like the described communications 652A and 654A respectively, in association with FOB device 470A. Likewise, communications 662B and 664B in association with FOB device 470B, function respectively like the described communications 662A and 664A, in association with FOB device 470A.

Distance range limitations of the wireless communication technology employed by the FOB devices 470A-470B, indicate that if the device 470b responds with a communication 474 for example, then the device 470B is within physical proximity of the FOB device 470a. For Bluetooth low energy embodiments, this distance range limitation should be approximately 50 meters or less, depending upon the physical environment between the FOB device 470a and the FOB device 470b.

If the communication 644 indicates that devices 470a-470b are proximate to each other and indicate a successful finger print scan match for both participants 680a and 680b, then it can be inferred that it is likely that an authorized participant 680a is located in physical proximity to the device 470a, and the authorized participant 680b is located in physical proximity to the device 470b, and both participants 680a-680b are located in proximity to each other. Else if, either device 470a or 470b do not indicate a successful finger print scan match and/or a time out occurs, then it can be inferred that both authorized participants 680a-680b are not located within proximity to each other.

In accordance with the invention, communications are preferably communicated in a secure manner. In one embodiment, the secure manner employs public key infrastructure (PKI) methodology. In this embodiment, the IVS 150, the FOB device 470a-470b, and the health care provider organization 640 are each assigned a unique pair of encryption keys. Each pair of encryption keys includes a public encryption key and a private encryption key. Details of how PKI methodology is applied to the above described system are described in association with FIG. 5.

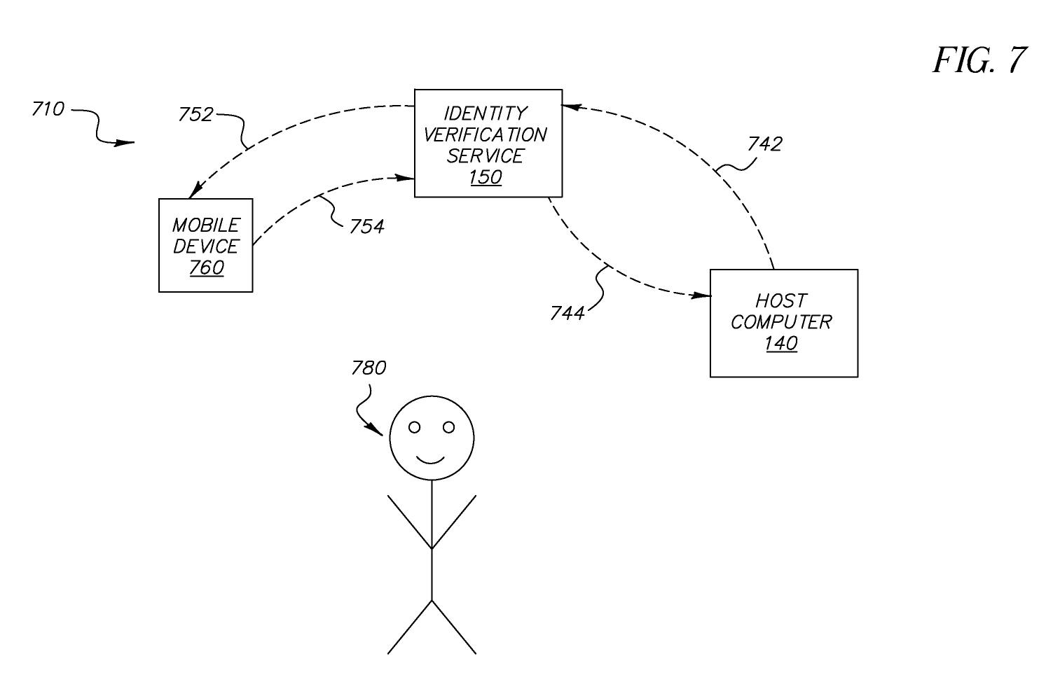

FIG. 7 illustrates an embodiment of an identity verification system 710 incorporating an enhanced mobile telephone device 760, also referred to herein as a mobile device 760. As shown, the system 710 operates without requiring a holder 780 of the mobile device 760 to also possess a special FOB device 170, 470a-470b. To replace the IVS FOB device 170, 470a-470b, the mobile device 760 is designed to perform at least one type of biometric measurement function, and is further enhanced by incorporating a software application that enables the mobile device 760 to function as if it were the FOB device 170, 470a-470b. This “FOB-less” design variation can be applied (is applicable) to the prior described identity verification systems of FIGS. 1, 3-4 and 6.

In this embodiment, for example, communication 742 functions like communication 442 of FIG. 4 and communication 752 functions like communication 452 of FIG. 4. In response to receiving communication 752, the mobile device 760, instead of relaying the content of the communication 752 to a IVS FOB device 170, 470a-470b, the mobile device 760 instead performs the functions that would otherwise be performed by the IVS FOB device 170, 470a-470b using its own biometric measurement capabilities. There is no need for wireless communication between the mobile device 760 and another wireless device, such as the IVS FOB device 170, 470a-470b.

The software application of the mobile device 760 manages communication between the mobile device 760 and the identity verification service (IVS) 150, and transmits a communication 754 that includes information content that is like that of communication 454 of FIG. 4. The IVS 150 processes and relays the content of this communication 754 by transmitting communication 744, which functions like communication 444 of FIG. 4, to the host computer 140. The information content of communication 744, like that of the communication 144 of FIG. 1, the communication 244 of FIG. 3 and the communication 444 of FIG. 4, provides information constituting either a verification or a non-verification of an identity of a particular holder of a card, that is associated with the information content of communication 742.

In some embodiments, the mobile device 760 is configured to wirelessly communicate and interoperate with a card 120 in the same manner as the FOB device 170, as described in association with examples employing the card 120 of FIGS. 1, 3, 5. In this type of embodiment, the card 120 may or may not embed a biometric measurement feature. If the card 120 lacks a biometric measurement feature, it can still perform other types of operations, such as responding to a transaction approval request, and if a transaction approval request is approved by the holder of the mobile device 760 and card 120, then the device 760 communicate the transaction approval to the card 120, causing the card 120 to take some action, including, in some circumstances, a release of protected information, like the action the card 120 performs when receiving communication 172a, which is a biometric approval communication 172a.

In some embodiments, the mobile device can also provide global positioning system (GPS) coordinates in outbound communications, such as within communication 754, to provide an approximate location of a holder 780 of the mobile device 760 while the holder 780 is performing a finger print swipe scan in response to the mobile device 760 receiving an identity verification request from the IVS 150, for example.

In summary, the invention provides for a system for verifying an identity of a person, including a biometric measurement device, a card including a set of electronics and a wireless transceiver that configured to be inserted into a card reader, and where said set of electronics is configured to release securely protected information in response to a receiving of a biometric approval communication from said biometric device, and where the biometric measurement device has a defined association with the card, and where the biometric approval communication being transmitted from said biometric measurement device to the card, in response to said biometric measurement device receiving an identity verification request, the identity verification request being a request to verify that a person, that is specified by the identity verification request, is equivalent to a person who is determined by the biometric identification device, to be a current holder of said biometric device, and where the biometric approval communication is not being transmitted from said biometric measurement device unless and until said current holder of said biometric device is determined to be the same said person as specified by said identity verification request.

In some embodiments, the card is issued by an institution and the securely protected information is released to the institution. Optionally the institution communicates with an identity verification service to verify the identity of a holder of the card at a current time, and the identity verification service transmits the identity verification request to the biometric measurement device that is known to be held by a person that is also known as a holder of the card. Optionally, the biometric measurement device is authenticated by the card via information received by the card from the biometric approval communication. Optionally, the identity verification service is authenticated by the biometric measurement device via a communication transmitted by the identity verification service and received by the biometric measurement device. Optionally, the identity verification request is transmitted from an identity verification service and relayed to said biometric measurement device via a mobile telephone device. Optionally, the card is issued by a financial institution, and the card is employed to perform a financial transaction.

In some embodiments, the biometric device prompts a holder of the biometric device to perform a biometric match operation, and if the match operation is successful, the biometric device transmits the secure biometric approval communication via a wireless protocol to at least one of said card and said identity verification service. Optionally, at least one of the card and the identity verification service relays at least a portion of said securely protected information to said institution. Optionally, the system is a health care providing institution. Optionally, the biometric measurement device is configured to wirelessly communicates with at least one other biometric measurement device.

In another aspect, the apparatus provides an apparatus for verifying an identity of a card holder, including a card including a set of electronics and a wireless transceiver and that is configured to be inserted into a card reader, and where the set of electronics is configured to release information via the card holder upon engagement with the card holder, and where the set of electronics is configured to release securely protected information via the card reader in response to a receiving of a biometric approval communication: the card being configured to wirelessly communicate with a portable biometric measurement device; and the card being configured to receive the biometric approval communication via wirelessly communicating with the portable biometric measurement device.

Optionally, the card is configured to communicate with a mobile telephone via said biometric measurement device. Optionally, the card is configured to communicate with an identity verification service via wireless communication with said biometric measurement device. Optionally, the card is configured to communicate with an identity verification service via wireless communication with a mobile telephone.

In another aspect, the invention provides for an apparatus for verifying an identity of a person, including a portable biometric measurement device including a set of electronics, a user interface display, a set of user interface controls, and a wireless transceiver, and where the set of electronics is configured to prompt the holder of the device to perform a fingerprint scan swipe procedure; and where the set of electronics is configured to receive an identity verification request from a first other entity via wireless communication; and where the set of electronics is configured to perform a biometric matching operation and report results of the biometric matching operation; and where the results are reported via wireless communication with a second entity.

Optionally, the first other entity is an identity verification service. Optionally, the first other entity is at least one of a card and a card reader, said card being inserted into a card reader. Optionally, the first other entity is mobile telephone device. Optionally, the second entity is at least one of a card that is inserted into a card reader, a mobile telephone device and an identity verification service.

What is claimed is:

1. A system for verifying an identity of a person, comprising:
a biometric measurement device;
a card including a set of electronics and a wireless transceiver that configured to be inserted into a card reader, and where said set of electronics is configured to release securely protected information in response to a receiving of a biometric approval communication from said biometric device,
said biometric measurement device having a defined association with said card;
said biometric approval communication being transmitted from said biometric measurement device to said card, in response to said biometric measurement device receiving an identity verification request, said identity verification request being a request to verify that a person, that is specified by the identity verification request, is equivalent to a person who is determined by the biometric identification device, to be a current holder of said biometric device;
said biometric approval communication not being transmitted from said biometric measurement device unless and until said current holder of said biometric device is determined to be the same said person as specified by said identity verification request.

2. The system of claim 1 wherein said card is issued by an institution and wherein said securely protected information is released to said institution.

3. The system of claim 2 wherein said institution communicates with an identity verification service to verify the identity of a holder of said card at a current time, and said identity verification service transmits said identity verification request to said biometric measurement device that is known to be held by a person that is also known as a holder of said card.

4. The system of claim 1 where said biometric measurement device is authenticated by said card via information received by said card from said biometric approval communication.

5. The system of claim 3 where said identity verification service is authenticated by said biometric measurement device via a communication transmitted by said identity verification service and received by said biometric measurement device.

6. The system of claim 1 where said identity verification request is transmitted from an identity verification service and relayed to said biometric measurement device via a mobile telephone device.

7. The system of claim 1 where said card is issued by a financial institution, and said card is employed to perform a financial transaction.

8. The system of claim 3 wherein said biometric device prompts a holder of said biometric device to perform a biometric match operation, and if said match operation is successful, said biometric device transmits said secure biometric approval communication via a wireless protocol to at least one of said card and said identity verification service.

9. The system of claim 8 wherein said at least one of said card and said identity verification service relays at least a portion of said securely protected information to said institution.

10. The system of claim 2 wherein said system is a health care providing institution.

11. The system of claim 2 wherein said biometric measurement device is configured to wirelessly communicates with at least one other biometric measurement device.

12. An apparatus for verifying an identity of a card holder, comprising;
a card including a set of electronics and a wireless transceiver and that is configured to be inserted into a card reader, and
where said set of electronics is configured to release information via said card holder upon engagement with said card holder; and
where said set of electronics is configured to release securely protected information via said card reader in response to a receiving of a biometric approval communication;
said card being configured to wirelessly communicate with a portable biometric measurement device; and
said card being configured to receive said biometric approval communication via wireless communicating with said portable biometric measurement device.

13. The apparatus of claim 12 wherein said card is configured to communicate with a mobile telephone via said biometric measurement device.

14. The apparatus of claim 12 wherein said card is configured to communicate with an identity verification service via wireless communication with said biometric measurement device.

15. The apparatus of claim 12 wherein said card is configured to communicate with an identity verification service via wireless communication with a mobile telephone.

16. An apparatus for verifying an identity of a person, comprising;
a portable biometric measurement device including a set of electronics, a user interface display, a set of user interface controls and a wireless transceiver;
wherein said set of electronics is configured to prompt the holder of the device to perform a fingerprint scan swipe procedure; and
wherein said set of electronics is configured to receive an identity verification request from first other entity via wireless communication; and
wherein said set of electronics is configured to perform a biometric matching operation and report results of said biometric matching operation; and
wherein said results are reported via wireless communication with a second entity.

17. The apparatus of claim 16 wherein said first other entity is an identity verification service.

18. The apparatus of claim 16 wherein said first other entity is at least one of a card and a card reader, said card being inserted into a card reader.

19. The apparatus of claim 16 wherein said first other entity is mobile telephone device.

20. The apparatus of claim 16 wherein said second entity is at least one of a card that is inserted into a card reader, a mobile telephone device and an identity verification service.
